(19) United States
(12) Patent Application Publication
(10) Pub. No.: US 2025/0161862 A1
(43) Pub. Date: May 22, 2025

(54) LOW OXYGEN AIR SUPPLY SYSTEM

(71) Applicant: DAIKIN INDUSTRIES, LTD., Osaka (JP)

(72) Inventors: Yasutaka KOGA, Osaka (JP); Teruaki TSUCHIYA, Osaka (JP); Yutaro KASHIMA, Osaka (JP); Keita KONDO, Osaka (JP); Hiroyuki NAKATANI, Osaka (JP)

(21) Appl. No.: 19/030,012

(22) Filed: Jan. 17, 2025

Related U.S. Application Data
(63) Continuation of application No. PCT/JP2023/021459, filed on Jun. 9, 2023.

(30) Foreign Application Priority Data
Jul. 21, 2022 (JP) 2022-116439

(51) Int. Cl. B01D 53/047; A63B 69/00

(52) U.S. Cl. CPC B01D 53/0476; A63B 69/0048; B01D 2253/108; B01D 2256/12; B01D 2257/102; B01D 2258/06; B01D 2259/40003; B01D 2259/40009

(57) ABSTRACT

A low oxygen air supply system includes first and second low oxygen air supply units, a fan to supply the first target space with outdoor air, at least one oxygen sensor to detect oxygen concentration in the first target space, and a control unit to control behavior of the first low oxygen air supply unit, the second low oxygen air supply unit, and the fan. Each of the first low oxygen air supply unit and the second low oxygen air supply unit generates a low oxygen air lower in oxygen concentration than air and supply a first target space with the low oxygen air thus generated.

### CROSS-REFERENCE TO RELATED APPLICATIONS

This is a continuation of International Application No. PCT/JP2023/021459 filed on Jun. 9, 2023, which claims priority under 35 U.S.C. § 119(a) to Patent Application No. 2022-116439, filed in Japan on Jul. 21, 2022, all of which are hereby expressly incorporated by reference into the present application.

### BACKGROUND

### Technical Field

The present disclosure relates to a low oxygen air supply system.

### Background Art

A conventionally known low oxygen air supply system is configured to generate an air (hereinafter, referred to as a low oxygen air) having a lower oxygen concentration than the oxygen concentration (about 21%) in the air and supply a user with the atmosphere thus generated (see Japanese Laid-Open Patent Publication No. 2020-131121). The low oxygen air supply system is exemplarily used to create a low oxygen environment for high-altitude training in a simulated highland environment in an indoor space.

### SUMMARY

The present disclosure provides a low oxygen air supply system including: a first low oxygen air supply unit and a second low oxygen air supply unit each configured to generate a low oxygen air lower in oxygen concentration than air and supply a first target space with the low oxygen air thus generated; a fan configured to supply the first target space with outdoor air; at least one oxygen sensor configured to detect oxygen concentration in the first target space; and a control unit configured to control behavior of the first low oxygen air supply unit, the second low oxygen air supply unit, and the fan.

### BRIEF DESCRIPTION OF THE DRAWINGS

FIG. 1 is a schematic configuration diagram of a low oxygen air supply system according to an embodiment of the present disclosure.

FIG. 2 is a pattern perspective view of a low oxygen air supply system according to an embodiment of the present disclosure.

FIG. 3 is a block diagram of a low oxygen air supply system according to an embodiment of the present disclosure.

FIG. 4A is a block diagram of a low oxygen air supply unit according to a first embodiment.

FIG. 4B is a block diagram of a low oxygen air supply unit according to a second embodiment.

FIG. 4C is a block diagram of a low oxygen air supply unit according to a third embodiment.

FIG. 5A is a pattern perspective view of the low oxygen air supply unit.

FIG. 5B is a pattern perspective view of an integral unit.

FIG. 6 is an exemplary chart of a business schedule of a store adopting the low oxygen air supply system and an operation schedule of the low oxygen air supply system.

FIG. 7 includes graphs indicating oxygen concentration and carbon dioxide concentration during preparatory operation, the numbers of low oxygen air supply units and supply fans in operation, and a change in the number of users of the low oxygen air supply system.

FIG. 8 includes graphs indicating oxygen concentration and carbon dioxide concentration during business operation, the numbers of low oxygen air supply units and supply fans in operation, and a change in the number of users of the low oxygen air supply system.

FIG. 9 includes graphs indicating oxygen concentration and carbon dioxide concentration during closing operation, the numbers of low oxygen air supply units and supply fans in operation, and a change in the number of users of the low oxygen air supply system.

FIG. 10 is a graph indicating periodical variations of supply air quantity and supply air pressure of the low oxygen air supply unit.

### DETAILED DESCRIPTION OF EMBODIMENT(S)

An oxygen supplier according to the present disclosure will be described in detail hereinafter with reference to the accompanying drawings. The present disclosure should not be limited to the following exemplifications, and is intended to include any modification recited in the claims within meanings and a scope equivalent to those of the claims.

### (Low Oxygen Air Supply System)

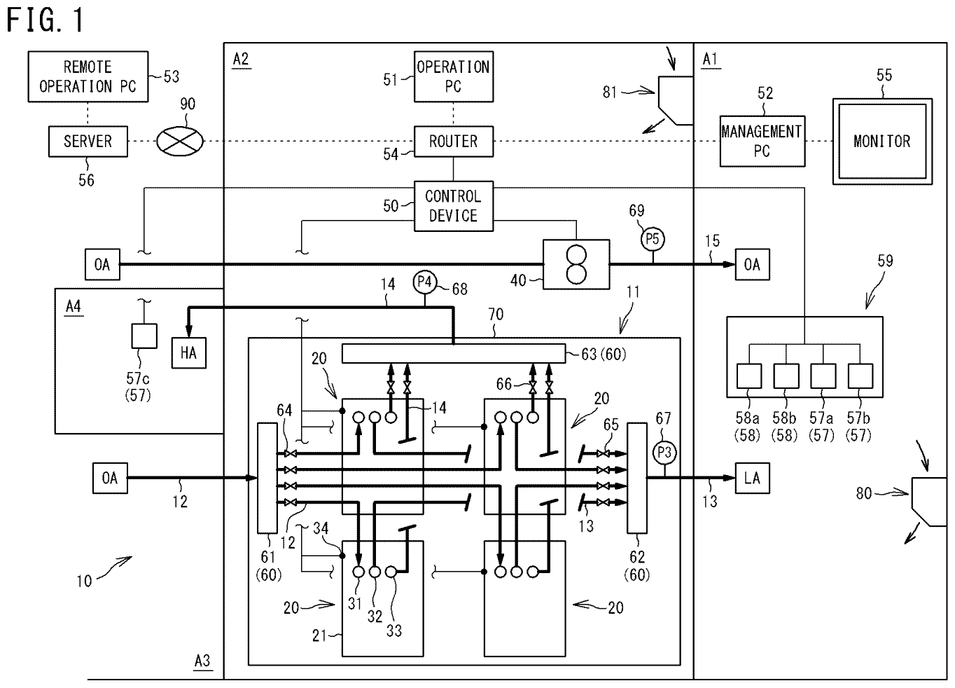

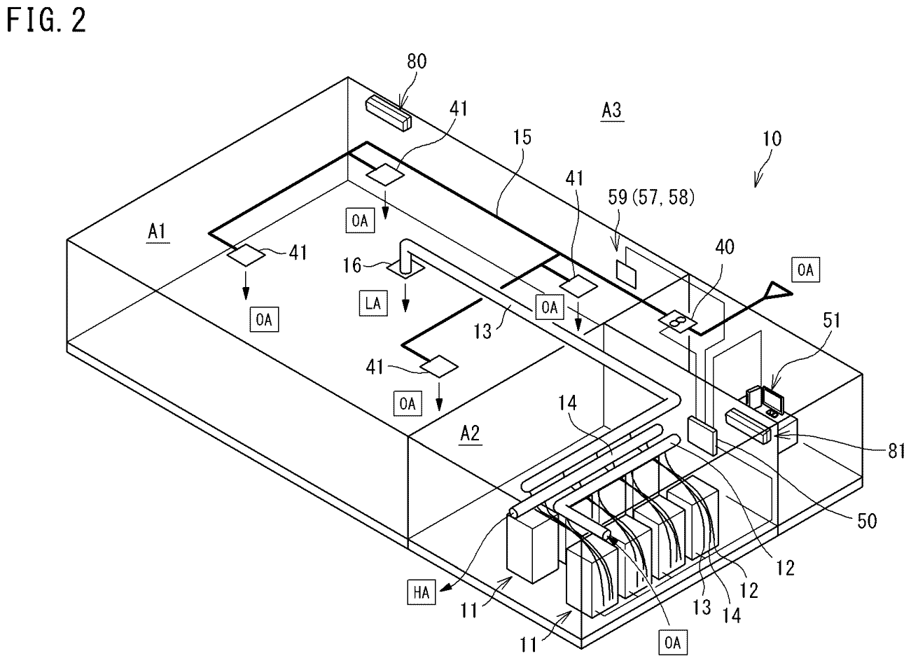

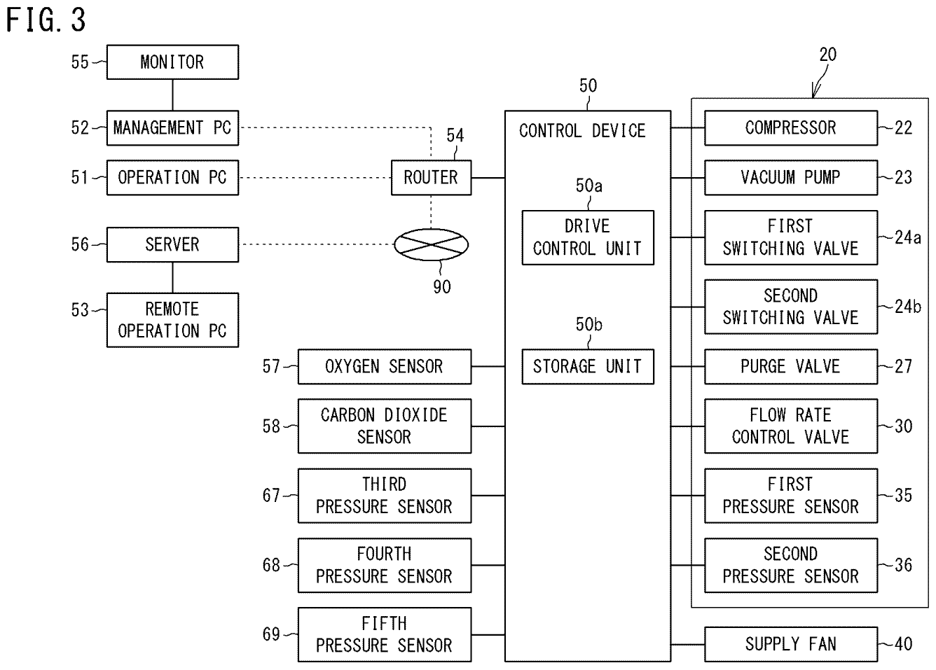

FIG. 1 is a schematic configuration diagram of a low oxygen air supply system according to an embodiment of the present disclosure. FIG. 2 is a pattern perspective view of a low oxygen air supply system according to an embodiment of the present disclosure. FIG. 3 is a block diagram of a low oxygen air supply system according to an embodiment of the present disclosure. FIG. 1 and FIG. 2 depicts a low oxygen air supply system 10 as a low oxygen air supply system according to an embodiment of the present disclosure. The low oxygen air supply system 10 is configured to generate an atmosphere (hereinafter, referred to as a low oxygen air LA) having a lower oxygen concentration than the oxygen concentration (about 21%) of the air and supply a target space with the atmosphere thus generated. The low oxygen air supply system 10 supplies an indoor space (a first target space) A1 with the low oxygen air LA to create a low oxygen environment for high-altitude training in the indoor space A1. The low oxygen air supply system 10 is configured to generate the low oxygen air LA and simultaneously generate an atmosphere (hereinafter, referred to as a high oxygen atmosphere HA) having a higher oxygen concentration than the oxygen concentration (about 21%) of the air.

As depicted in FIG. 1 to FIG. 3, the low oxygen air supply system 10 includes an integral unit 11, a supply fan 40, and a control device 50. As depicted in FIG. 2, the low oxygen air supply system 10 includes a plurality of integral units 11. As depicted in FIG. 1, the integral units 11 includes a plurality of low oxygen air supply units 20. The control device 50 is connected to the plurality of low oxygen air supply units 20 and the supply fan 40 to control behavior of these elements.

As depicted in FIG. 1 and FIG. 2, the integral units 11, the supply fan 40, and the control device 50 included in the low oxygen air supply system 10 according to the present embodiment are installed in a machine chamber A2. The machine chamber A2 according to the present embodiment corresponds to a space adjacent to the indoor space A1. In the following description, a space outside the indoor space A1 and the machine chamber A2 will be referred to as an outdoor space A3. The outdoor space A3 exemplified in the present embodiment is located outdoors. The outdoor space A3 may alternatively be located indoors.

The low oxygen air supply system 10 according to the present embodiment is used along with an air conditioner 80 configured to heat or cool air in the indoor space A1. The air conditioner 80 conditions temperature in the indoor space A1.

As depicted in FIG. 1, the low oxygen air supply system 10 according to the present disclosure creates a high oxygen environment in a high oxygen chamber (a second target space) A4. FIG. 2 does not depict the high oxygen chamber A4. The low oxygen air supply system 10 supplies the high oxygen chamber A4 with the high oxygen atmosphere HA. A person staying in the high oxygen chamber A4 is expected to suck the high oxygen atmosphere HA to effectively help with recovery from exhaustion. The high oxygen chamber A4 can exemplarily be utilized for recovery from exhaustion of a user having conducted high-altitude training in the indoor space A1. In this manner, the low oxygen air supply system 10 according to the present disclosure includes the high oxygen chamber A4 for effective utilization of the high oxygen atmosphere HA thus generated. The low oxygen air supply system 10 according to the present embodiment includes the high oxygen chamber A4. The low oxygen air supply system 10 according to the present disclosure may alternatively include no high oxygen chamber A4 to be configured to exhaust the high oxygen atmosphere HA thus generated to outdoors.

As depicted in FIG. 1 and FIG. 2, the low oxygen air supply system 10 includes an outdoor air supply tube 12, a low oxygen air supply tube 13, and a high oxygen atmosphere supply tube 14. The outdoor air supply tube 12 is configured to supply each of the integral units 11 with air (hereinafter, referred to as outdoor air OA) to be used for generation of the low oxygen air LA and the high oxygen atmosphere HA. The low oxygen air supply tube 13 is configured to supply the indoor space A1 with the low oxygen air LA generated in each of the integral units 11. The high oxygen atmosphere supply tube 14 is configured to supply the high oxygen chamber A4 with the high oxygen atmosphere HA generated in each of the integral units 11.

The low oxygen air supply system 10 is configured to supply the indoor space A1 with the low oxygen air LA generated in each of the low oxygen air supply units 20 via the low oxygen air supply tube 13 and a supply port 16. The outdoor air supply tube 12 exemplified in the present embodiment has a first end opened to the outdoor space A3 so as to suck the air (the outdoor air OA) in the outdoor space A3 via the first end. The outdoor air supply tube 12 may alternatively have the first end opened to the machine chamber A2 to be configured to suck the air (the outdoor air OA) in the machine chamber A2 via the first end. In this case, the machine chamber A2 has a wall surface provided with a vent hole configured to import the outdoor air OA to the machine chamber A2 from the outdoor space A3. The machine chamber A2 is preferably heated or cooled by an air conditioner 80.

The low oxygen air supply system 10 further includes an outdoor air duct 15 allowing communication between the indoor space A1 and the outdoor space A3. The supply fan 40 is disposed at a halfway point of the outdoor air duct 15. When the supply fan 40 actuates, the low oxygen air supply system 10 supplies the indoor space A1 with the outdoor air OA via the outdoor air duct 15 and a blow-out port 41. The low oxygen air supply system 10 may alternatively include a filter having a deodorant effect and disposed at a halfway point of the low oxygen air supply tube 13 to be configured to remove specific odor of the low oxygen air LA. The low oxygen air supply system 10 may still alternatively include a device configured to provide the low oxygen air LA with a scent with use of aroma oil or the like and disposed at a halfway point of the low oxygen air supply tube 13 so as to supply the indoor space A1 with the low oxygen air LA thus scented.

### (Low Oxygen Air Supply Unit)

The present embodiment describes a method of generating a low oxygen air by the low oxygen air supply unit with use of a nitrogen adsorbent. However, the present disclosure is not limited to this method and may exemplarily adopt a membrane separation method with use of a hollow fiber membrane.

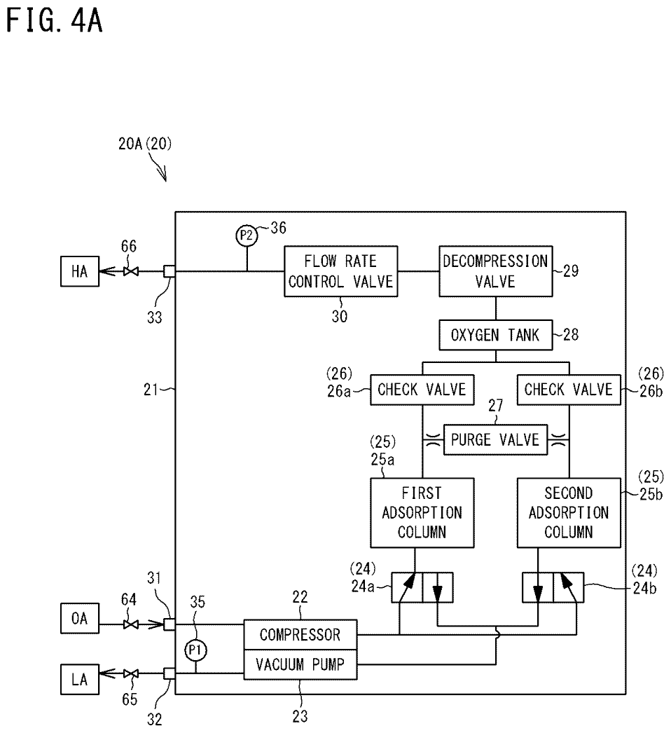

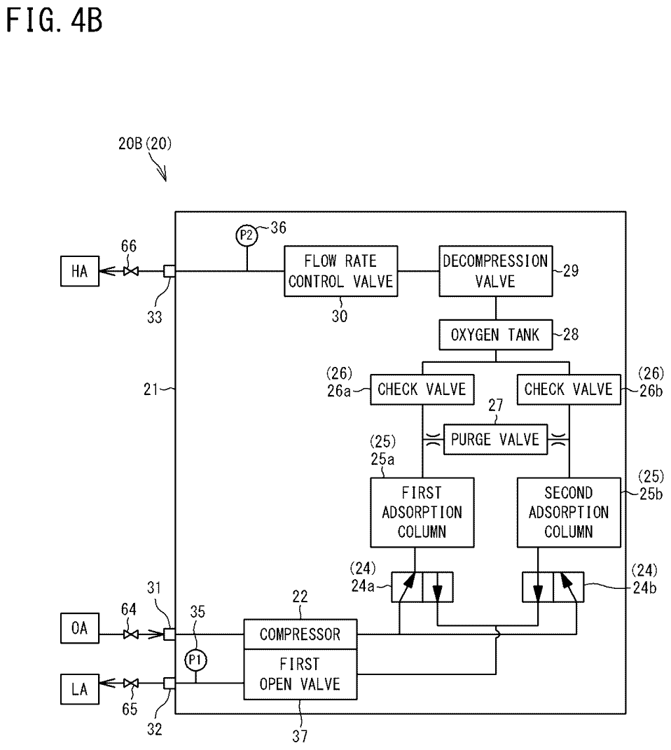

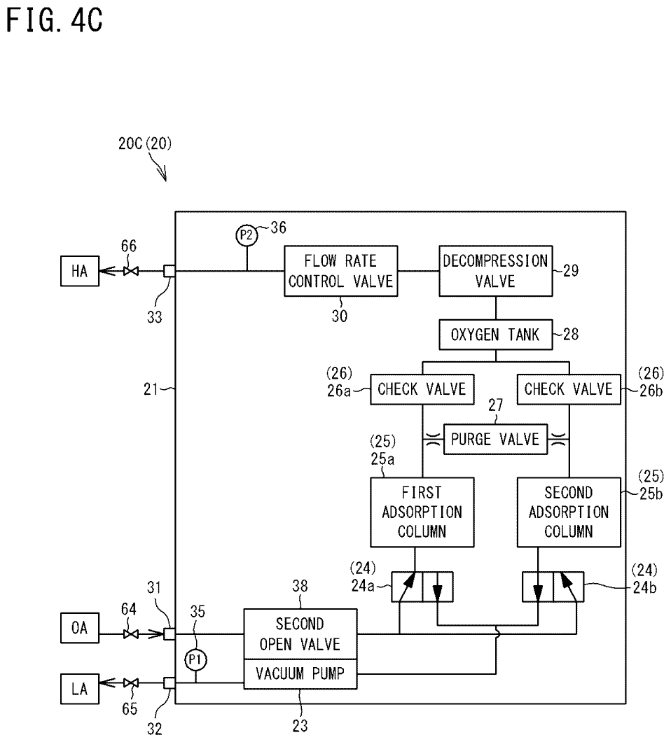

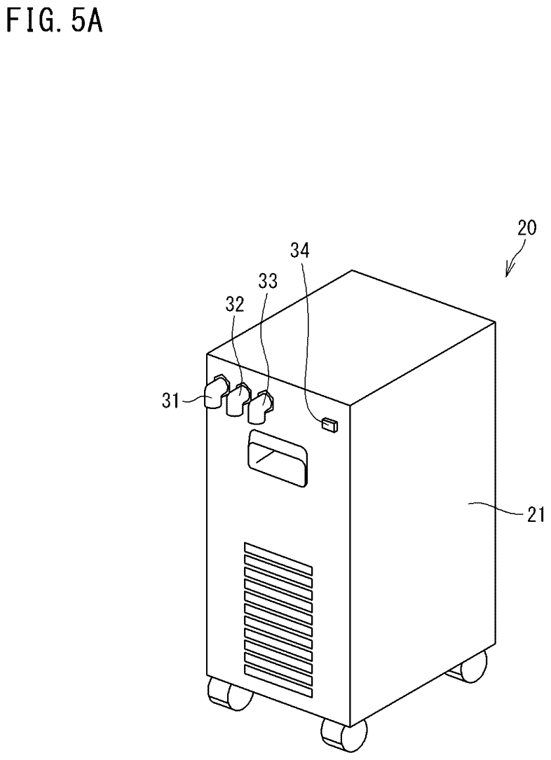

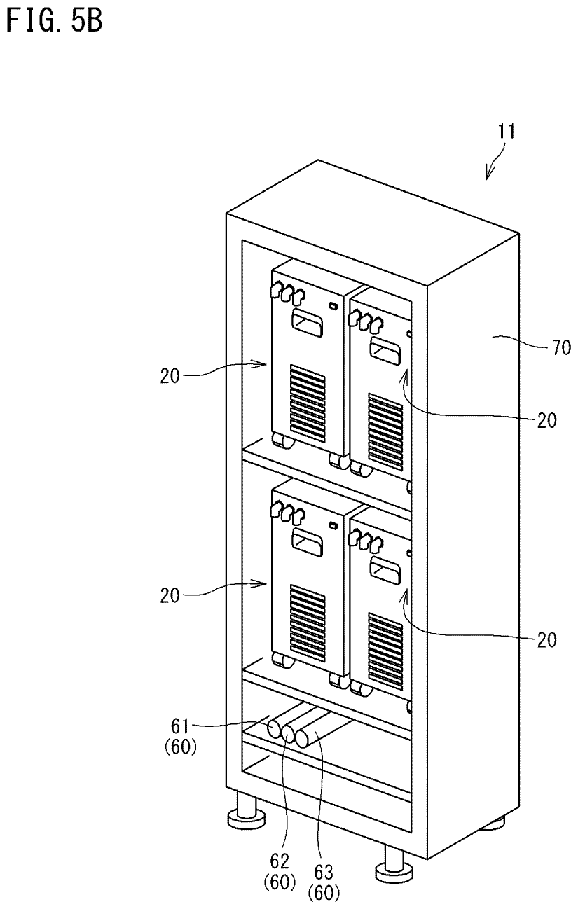

FIG. 4A is a block diagram of a low oxygen air supply unit according to a first embodiment. FIG. 5A is a pattern perspective view of the low oxygen air supply unit. The low oxygen air supply unit 20 corresponds to a minimum element configured to generate the low oxygen air LA. In the following description, the low oxygen air supply unit 20 according to the first embodiment will also be referred to as a first unit 20A. When the following description mentions the “low oxygen air supply unit 20”, the description will refer to a common configuration among the first unit 20A and low oxygen air supply units 20 (a second unit 20B depicted in FIG. 4B and a third unit 20C depicted in FIG. 4C) according to other embodiments to be described later.

Initially described hereinafter is the configuration of the first unit 20A. As depicted in FIG. 4A and FIG. 5A, the first unit 20A includes a case 21, a compressor 22, a vacuum pump 23, a flow path switching valve 24, an adsorption column 25, a check valve 26, a purge valve 27, an oxygen tank 28, a decompression valve 29, and a flow rate control valve 30. The first unit 20A includes the case 21 accommodating the compressor 22, the vacuum pump 23, the flow path switching valve 24, the adsorption column 25, the check valve 26, the purge valve 27, the oxygen tank 28, the decompression valve 29, and the flow rate control valve 30. The compressor 22 and the vacuum pump 23 included in the first unit 20A may alternatively be constituted as integral fluid machinery. In a case where exhaust air from the vacuum pump 23 is utilized as the low oxygen air LA, the following description may refer to the exhaust air from the vacuum pump 23 as “supply air”.

As depicted in FIG. 4A and FIG. 5A, the low oxygen air supply unit 20 includes an outdoor air intake port 31, a low oxygen air exhaust port 32, and a high oxygen atmosphere exhaust port 33. The outdoor air intake port 31 is a part connected to a tube configured to import the outdoor air OA into the low oxygen air supply unit 20, and includes a joint configured to connect the tube. The low oxygen air exhaust port 32 is a part connected to a tube configured to exhaust the low oxygen air LA generated in the low oxygen air supply unit 20 to outside, and includes a joint configured to connect the tube. The high oxygen atmosphere exhaust port 33 is a part connected to a tube configured to exhaust the high oxygen atmosphere HA generated in the low oxygen air supply unit 20 to outside, and includes a joint configured to connect the tube. The low oxygen air supply unit 20 includes a port 34 (see FIG. 1 and FIG. 5A) configured to connect wiring and provided in a surface of the case 21. The wiring connected to the port 34 is connected to the control device 50.

As depicted in FIG. 4A, the compressor 22 compresses air (the outdoor air OA) sucked from outside (the outdoor space A3) and supplies the adsorption column 25 with the compressed air via the flow path switching valve 24. The vacuum pump 23 sucks to exhaust air having passed through the adsorption column 25.

The adsorption column 25 is a pressure vessel accommodating an adsorbent X configured to adsorb nitrogen in the compressed air supplied from the compressor 22. The adsorption column 25 is constituted by a first adsorption column 25a and a second adsorption column 25b. The Low oxygen air supply unit 20 according to the present embodiment adopts zeolite as the adsorbent X. The adsorbent used in the low oxygen air supply unit according to the present disclosure is not limited to this and may exemplarily be configured to adsorb oxygen.

The adsorbent (zeolite) X is configured to adsorb nitrogen contained in the air. When the adsorbent X adsorbing nitrogen is decompressed, the adsorbent can separate (release) the adsorbed nitrogen. The air passing through a space filled with the adsorbent X is increased in oxygen concentration due to adsorption of nitrogen. The air passing through a space filled with the adsorbent X adsorbing nitrogen is decreased in oxygen concentration due to release of the nitrogen from the adsorbent X. The low oxygen air supply unit 20 is configured to generate the low oxygen air LA and the high oxygen atmosphere HA with use of a function of adsorbing nitrogen and a function of releasing adsorbed nitrogen by the adsorbent X.

One of the first adsorption column 25a and the second adsorption column 25b in the adsorption column 25 generates the high oxygen atmosphere HA and the other one generates the low oxygen air LA. The flow path switching valve 24 is constituted by a first switching valve 24a and a second switching valve 24b. The first adsorption column 25a is switched by the first switching valve 24a into a state in communication with the compressor 22 and a state in communication with the vacuum pump 23. The second adsorption column 25b is switched by the second switching valve 24b into a state in communication with the vacuum pump 23 when the first adsorption column 25a is in communication with the compressor 22, and is switched into a state in communication with the compressor 22 when the first adsorption column 25a is in communication with the vacuum pump 23.

The oxygen tank 28 reserves the high oxygen atmosphere HA generated in the first adsorption column 25a and the second adsorption column 25b.

The first unit 20A according to the present embodiment adopts an oxygen concentration method of a vacuum pressure swing adsorption system (VPSA) type including sucking to decompress with use of the vacuum pump 23 one of the first adsorption column 25a and the second adsorption column 25b while the other one of the first adsorption column 25a and the second adsorption column 25b is supplied with compressed air. The low oxygen air supply system 10 according to the present disclosure may alternatively adopt the oxygen concentration method other than the VPSA type. The low oxygen air supply system 10 according to the present disclosure may adopt the oxygen concentration method of a pressure swing adsorption system (PSA) type including atmospherically opening to decompress one of the first adsorption column 25a and the second adsorption column 25b while the compressor 22 supplies the other one of the first adsorption column 25a and the second adsorption column 25b with compressed air, or exhausting to decompress one of the first adsorption column 25a and the second adsorption column 25b with use of the vacuum pump 23 while the other one of the first adsorption column 25a and the second adsorption column 25b is atmospherically opened.

FIG. 4B is a block diagram of a low oxygen air supply unit according to a second embodiment. The low oxygen air supply system 10 according to the present disclosure may alternatively include the low oxygen air supply unit 20 depicted in FIG. 4B. In the following description, the low oxygen air supply unit 20 according to the second embodiment will also be referred to as the second unit 20B. The second unit 20B depicted in FIG. 4B is different from the first unit 20A in that a first open valve 37 replaces the vacuum pump 23, and is common to the first unit 20A in the remaining configuration.

In the second unit 20B, the adsorbent X adsorbs nitrogen in the air in one of the first adsorption column 25a and the second adsorption column 25b compressed by the compressor 22 and the adsorbent X releases adsorbed nitrogen in the other one atmospherically opened by a second open valve 38, to generate the low oxygen air LA and the high oxygen atmosphere HA. The second unit 20B according to the present embodiment includes the first open valve 37 that may be excluded. In this case, the flow path switching valve 24 functions as the first open valve 37.

FIG. 4C is a block diagram of a low oxygen air supply unit according to a third embodiment. The low oxygen air supply system 10 according to the present disclosure may alternatively include the low oxygen air supply unit 20 depicted in FIG. 4C. In the following description, the low oxygen air supply unit 20 according to the third embodiment will also be referred to as the third unit 20C. The third unit 20C depicted in FIG. 4C is different from the first unit 20A in that the second open valve 38 replaces the compressor 22, and is common to the first unit 20A in the remaining configuration.

In the third unit 20C, the adsorbent X adsorbs nitrogen in the air in one of the first adsorption column 25a and the second adsorption column 25b atmospherically opened by the second open valve 38 and the adsorbent X releases adsorbed nitrogen in the other one decompressed by the vacuum pump 23, to generate the low oxygen air LA and the high oxygen atmosphere HA. The third unit 20C according to the present embodiment includes the second open valve 38 that may be excluded. In this case, the flow path switching valve 24 functions as the second open valve 38.

The first switching valve 24a and the second switching valve 24b are so-called three port connection valves. As depicted in FIG. 4A, in the first unit 20A, the first switching valve 24a and the second switching valve 24b switch between a compressed state where the adsorption column 25 is supplied with compressed air discharged from the compressor 22 and a decompressed state where the vacuum pump 23 sucks to exhaust the air in the adsorption column 25 to outside. While one of the first adsorption column 25a and the second adsorption column 25b is in the compressed state, the other one is in the decompressed state.

As depicted in FIG. 4B, in the second unit 20B, the first switching valve 24a and the second switching valve 24b switch between the compressed state where the adsorption column 25 is supplied with compressed air discharged from the compressor 22 and an opened state where the first open valve 37 is “opened” to atmospherically open the interior of the adsorption column 25. While one of the first adsorption column 25a and the second adsorption column 25b is in the compressed state, the other one is in an atmospheric pressure state.

As depicted in FIG. 4C, in the third unit 20C, the first switching valve 24a and the second switching valve 24b switch between the decompressed state where the vacuum pump 23 sucks to exhaust the air in the adsorption column 25 to outside and the opened state where the second open valve 38 is “opened” to atmospherically open the interior of the adsorption column 25. While one of the first adsorption column 25a and the second adsorption column 25b is in the decompressed state, the other one is in the atmospheric pressure state.

The check valve 26 prevents backflows of low oxygen air and high oxygen atmosphere. The check valve 26 is constituted by a first check valve 26a and a second check valve 26b. The first check valve 26a is disposed on a flow path downstream of the first adsorption column 25a, and the second check valve 26b is disposed on a flow path downstream of the second adsorption column 25b. The low oxygen air supply unit 20 includes the first check valve 26a and the second check valve 26b so as to be configured to allow the high oxygen atmosphere HA exhausted from the first adsorption column 25a and the second adsorption column 25b to flow only downstream. The purge valve 27 is disposed on a flow path connecting a flow path between the first adsorption column 25a and the first check valve 26a and a flow path between the second adsorption column 25b and the second check valve 26b.

The high oxygen atmosphere HA from the first check valve 26a and the high oxygen atmosphere HA from the second check valve 26b are alternately supplied to the oxygen tank 28 to be reserved in the oxygen tank 28. Downstream of the oxygen tank 28, the decompression valve 29 configured to decompress the high oxygen atmosphere HA to be supplied from the oxygen tank 28 to outside and the flow rate control valve 30 configured to adjust a flow rate of the high oxygen atmosphere HA. The flow rate control valve 30 is configured to adjust the flow rate of the high oxygen atmosphere HA to be supplied from the oxygen tank 28 to outside.

In the first unit 20A depicted in FIG. 4A, the purge valve 27 is brought into an opened state when the vacuum pump 23 exhausts the air in one of the first adsorption column 25a and the second adsorption column 25b, and is provided to move the air in the other one of the first adsorption column 25a and the second adsorption column 25b into the one of the adsorption columns 25 via the purge valve 27 so as to efficiently exhaust the air in the one of the adsorption columns 25.

In the second unit 20B depicted in FIG. 4B, the purge valve 27 is brought into the opened state when the first open valve 37 is “opened” to atmospherically open the air in one of the first adsorption column 25a and the second adsorption column 25b. In the second unit 20B, the air in the other one of the first adsorption column 25a and the second adsorption column 25b is moved to the one of the adsorption columns 25 via the purge valve 27 to efficiently exhaust the air in the one of the adsorption columns 25.

In the third unit 20C depicted in FIG. 4C, the purge valve 27 is brought into the opened state when the second open valve 38 is “opened” to atmospherically open the air in one of the first adsorption column 25a and the second adsorption column 25b. In the second unit 20B, the air in the one of the adsorption columns 25 is moved to the other one of the adsorption columns 25 via the purge valve 27 to efficiently exhaust the air in the other one of the adsorption columns 25.

The flow rate control valve 30 is configured to adjust supply quantity of the high oxygen atmosphere HA. The low oxygen air supply unit 20 adjusts a valve opening degree of the flow rate control valve 30 so as to adjust a flow rate of the air discharged from the compressor 22 for adjustment in supply quantity of the high oxygen atmosphere HA. The low oxygen air supply unit 20 according to the present embodiment includes the flow rate control valve 30 that may be excluded. In this case, the supply quantity of the high oxygen atmosphere HA can be adjusted through adjustment of the number of revolutions of a motor (not depicted) configured to drive the compressor 22, or supply quantities of the high oxygen atmosphere HA and the low oxygen air LA can be adjusted through control of the number of low oxygen air supply units 20.

The low oxygen air supply system 10 according to the present disclosure includes the flow rate control valve 30 provided only in a tube system for the high oxygen atmosphere HA, and may further include another flow rate control valve 30 provided in a tube system for the low oxygen air LA. When the flow rate control valve 30 adjusts the supply quantity of the high oxygen atmosphere HA, the low oxygen air LA can be adjusted in oxygen concentration as well as flow rate. In the low oxygen air supply system 10 according to the present disclosure, the flow rate control valve 30 adjusts a flow rate of the high oxygen atmosphere HA to adjusts the oxygen concentration of the low oxygen air LA.

As described above, the low oxygen air supply unit 20 includes the flow rate control valve 30 configured to adjust supply quantity of the air from the compressor 22. In the low oxygen air supply system 10 thus configured, the flow rate of the high oxygen atmosphere HA is adjusted to enable adjustment of the flow rate of the low oxygen air LA. In this case, the flow rate of the low oxygen air LA can be adjusted with use of a flow rate control valve 30 smaller in size. This achieves cost reduction for installation of the flow rate control valve 30.

### (Integral Unit)

FIG. 5B is a pattern perspective view of an integral unit. As depicted in FIG. 1, FIG. 2, and FIG. 5B, each of the integral units 11 includes a plurality of low oxygen air supply units 20, a plurality of silencers 60, and a rack 70.

Each of the silencers 60 is a tube member having a header shape, and has a function as a header and a function as a displacement silencer. The silencers 60 include a first silencer 61 provided on a tube system for the outdoor air OA to be supplied to the low oxygen air supply units 20, a second silencer 62 provided on a tube system for the low oxygen air LA to be supplied from the low oxygen air supply units 20, and a third silencer 63 provided on a tube system for the high oxygen atmosphere HA to be supplied from the low oxygen air supply units 20.

As depicted in FIG. 1, the first silencer 61 is provided at a halfway point of the outdoor air supply tube 12 to divide the outdoor air supply tube 12 into a plurality of branches. In the integral unit 11, the plurality of outdoor air supply tubes 12 extending from the first silencer 61 is connected to the outdoor air intake ports 31 of the low oxygen air supply units 20. The first silencer 61 is configured to reduce noise propagating from the low oxygen air supply units 20 to outside via the outdoor air supply tubes 12.

The second silencer 62 is provided at a halfway point of the low oxygen air supply tube 13 to integrate a plurality of low oxygen air supply tubes 13. In the integral unit 11, the plurality of low oxygen air supply tubes 13 extending from the second silencer 62 is connected to the low oxygen air exhaust ports 32 of the low oxygen air supply units 20. The second silencer 62 is configured to reduce noise propagating from the low oxygen air supply units 20 to outside via the low oxygen air supply tubes 13.

The third silencer 63 is provided at a halfway point of the high oxygen atmosphere supply tube 14 to integrate a plurality of high oxygen atmosphere supply tubes 14. In the integral unit 11, the plurality of high oxygen atmosphere supply tubes 14 extending from the third silencer 63 is connected to the high oxygen atmosphere exhaust ports 33 of the low oxygen air supply units 20. The third silencer 63 is configured to reduce noise propagating from the low oxygen air supply units 20 to outside via the high oxygen atmosphere supply tubes 14.

The rack 70 is a shelf configured to mount the plurality of low oxygen air supply units 20 and the plurality of silencers 60. In the low oxygen air supply system 10 according to the present disclosure, the integral unit 11 is constituted by four low oxygen air supply units 20 and the first to third silencers 61 to 63, which are mounted on the single rack 70. The low oxygen air supply system 10 depicted in FIG. 2 includes eight integral units 11 and 32 low oxygen air supply units 20 in total. The number of the low oxygen air supply units 20 constituting the integral unit 11 is not limited to the number (four) exemplified in the present embodiment, and has only to be two or more. The number of the low oxygen air supply units 20 constituting the low oxygen air supply system 10 according to the present disclosure can be set as appropriate in consideration of the size of the indoor space A1, the number of users, and the like, and is not limited to the number (32) exemplified in the present embodiment.

As described above, in the low oxygen air supply system 10 according to the present embodiment, the low oxygen air supply units 20 are mounted on the rack 70. In the low oxygen air supply system 10 thus configured, the low oxygen air supply units 20 can be disposed three-dimensionally in each of the integral units 11. This reduces an installation space to facilitate installation of the low oxygen air supply system 10.

In the low oxygen air supply system 10 according to the present embodiment, the first silencer 61 merges the low oxygen air LA supplied from the plurality of low oxygen air supply units 20. The low oxygen air supply system 10 thus configured can be reduced in the number of the silencers 60 in comparison to a case where each of the low oxygen air supply units 20 is provided with the silencer 60. The low oxygen air supply system 10 can thus effectively reduce noise generated from the low oxygen air supply units 20 with the smaller number of the silencers 60. The present embodiment exemplifies the case where the integral units 11 are installed in the machine chamber A2. However, the integral units 11 is not limited to this case in terms of an installation site, and may alternatively be installed in the indoor space A1 or the like. In the low oxygen air supply system 10, the plurality of silencers 60 reduces noise generated from the low oxygen air supply units 20 to enable installation of the integral units 11 in the indoor space A1.

### (Supply Fan)

The supply fan 40 is configured to supply the indoor space A1 with the air (the outdoor air OA) in the outdoor space A3. The supply fan 40 according to the present embodiment sucks the air in the outdoor space A3, and may alternatively suck the air (the outdoor air OA) in the machine chamber A2. In this case, the wall surface of the machine chamber A2 is provided with a vent hole to allow the supply fan 40 to suck the outdoor air OA imported to the machine chamber A2 from the outdoor space A3 via the vent hole.

In the low oxygen air supply system 10 according to the present disclosure, the indoor space A1 is ventilated by the supply fan 40. In the low oxygen air supply system 10 according to the present disclosure, the indoor space A1 is provided with a clearance (not depicted) communicating with the outdoor space A3. Preferred examples of the clearance include an opening (undercut) provided in a lower portion of a door. The indoor space A1 has positive pressure when the supply fan 40 supplies the outdoor air OA, and the air flows from the clearance toward the machine chamber A2 and the outdoor space A3 lower in pressure to ventilate the indoor space A1. In the low oxygen air supply system 10, the supply fan 40 executes class 2 ventilation of the indoor space A1. In other words, In the low oxygen air supply system 10 according to the present disclosure, the air is not exhausted from the indoor space A1 with use of any exhaust fan. The low oxygen air supply system 10 according to the present disclosure merges, in the indoor space A1, the outdoor air OA supplied from the supply fan 40 and the low oxygen air LA supplied from the low oxygen air supply units 20. The low oxygen air supply system 10 thus configured achieves a reduction in the size (duct size) of the outdoor air duct 15.

### (Control Device)

The control device 50 depicted in FIG. 1 to FIG. 3 is connected to the low oxygen air supply units 20 and the supply fan 40 to control behavior of these elements. Exemplified herein is the case where the first unit 20A if adopted as the low oxygen air supply unit 20. As depicted in FIG. 3, the control device 50 includes a drive control unit 50a and a storage unit 50b. The drive control unit 50a controls behavior of the compressor 22, the vacuum pump 23, the flow path switching valve 24, the purge valve 27, the flow rate control valve 30, and the supply fan 40. The storage unit 50b preliminarily stores a program enabling individual control of all the low oxygen air supply units 20 included in the low oxygen air supply system 10.

The control device 50 is connected to an operation PC 51 and a management PC 52 via a communication cable and a router 54. The low oxygen air supply system 10 operates and stops in accordance with user operation and setting of the operation PC 51. The operation PC 51 includes a monitor (not depicted) configured to display information such as an actuation state of the low oxygen air supply system 10 and the supply quantity of the low oxygen air LA. The operation PC 51 is disposed near the integral unit 11 (the low oxygen air supply unit 20). The management PC 52 is disposed in the indoor space A1. The low oxygen air supply system 10 presents to a user in the indoor space A1 information such as current oxygen concentration and carbon dioxide concentration in the indoor space A1 with use of a monitor 55 connected to the management PC 52. In a case where the low oxygen air supply system 10 has abnormality, the control device 50 notifies of occurrence of the abnormality with use of the monitor connected to the operation PC 51 and the monitor 55 connected to the management PC 52. The present embodiment exemplifies the case where the management PC 52 is provided. However, the management PC 52 may be excluded. In this case, the operation PC 51 and the monitor 55 may be connected to present, with use of the operation PC 51 and the monitor 55, information such as oxygen concentration and carbon dioxide concentration in the indoor space A1.

The control device 50 is further connected to a remote operation PC 53 via an internet line 90 and a server 56. When a manager remotely operates the remote operation PC 53, the low oxygen air supply system 10 is configured to monitor operation, stoppage, oxygen concentration and carbon dioxide concentration in the indoor space A1, and the like. The low oxygen air supply system 10 according to the present disclosure may alternatively exclude the remote operation PC 53.

Though not depicted in FIG. 3, the first open valve 37 is connected to the control device 50 in a case where the low oxygen air supply system 10 includes the second unit 20B (see FIG. 4B), or the second open valve 38 is connected to the control device 50 in another case where the low oxygen air supply system 10 includes the third unit 20C (see FIG. 4C). In these cases, the control device 50 controls the first open valve 37 or the second open valve 38.

The control device 50 is further connected to a sensor unit 59. The sensor unit 59 is installed in the indoor space A1. The sensor unit 59 includes an oxygen sensor 57 and a carbon dioxide sensor 58.

The oxygen sensor 57 is configured to detect oxygen concentration in a space. The carbon dioxide sensor 58 is configured to detect carbon dioxide concentration in a space. In the low oxygen air supply system 10 according to the present disclosure, the oxygen sensor 57 for the indoor space A1 is constituted by two oxygen sensors 57 (a first oxygen sensor 57a and a second oxygen sensor 57b). In the low oxygen air supply system 10 according to the present disclosure, the carbon dioxide sensor 58 is constituted by two carbon dioxide sensors 58 (a first carbon dioxide sensor 58a and a second carbon dioxide sensor 58b). The present embodiment exemplifies the case where the low oxygen air supply system 10 includes two oxygen sensors 57 and two carbon dioxide sensors 58. The low oxygen air supply system 10 according to the present disclosure may alternatively include three or more oxygen sensors 57 and three or more carbon dioxide sensors 58.

The low oxygen air supply system 10 according to the present disclosure further includes an oxygen sensor 57 (a third oxygen sensor 57c) for the high oxygen chamber A4. The third oxygen sensor 57c is disposed in the high oxygen chamber A4 and detects oxygen concentration in the high oxygen chamber A4. In the low oxygen air supply system 10, the control device 50 is configured to calculate supply capacity of the low oxygen air LA (oxygen concentration in the low oxygen air LA and supply quantity of the low oxygen air LA) in the low oxygen air supply system 10 in accordance with a detection value (oxygen concentration in the high oxygen atmosphere HA) of the third oxygen sensor 57c. The low oxygen air supply system 10 thus configured compares supply capacity of the low oxygen air LA calculated in accordance with detection values of the third pressure sensor 67, the oxygen sensors 57, and the like in the indoor space A1, with supply capacity of the low oxygen air LA calculated in accordance with the detection value of the third oxygen sensor 57c to easily check normal functioning of the low oxygen air supply system 10. The third oxygen sensor 57c is not limitedly installed in the high oxygen chamber A4, and may alternatively be installed in the high oxygen atmosphere supply tube 14, the oxygen tank 28, or the like.

The control device 50 adjusts the supply quantity of the low oxygen air LA in accordance with the detection values of the oxygen sensors 57 (i.e., oxygen concentration in the indoor space A1). The control device 50 adjusts the supply quantity of the low oxygen air LA through adjustment of an opening degree of the flow rate control valve 30, change in the number of the low oxygen air supply units 20, or change in the number of revolutions of motors for the compressor 22 and the vacuum pump 23 in each of the low oxygen air supply units 20.

The control device 50 adjusts the supply quantity of the low oxygen air LA in accordance with the detection values of the carbon dioxide sensors 58 (i.e., carbon dioxide concentration in the indoor space A1). The low oxygen air supply system 10 decreases carbon dioxide concentration in the indoor space A1 by increasing the supply quantity of the low oxygen air LA (in other words, supply quantity of nitrogen) in a case where carbon dioxide concentration increases in the indoor space A1.

The control device 50 is further connected to a first pressure sensor 35 and a second pressure sensor 36. The first pressure sensor 35 and the second pressure sensor 36 are installed in the case 21.

The first pressure sensor 35 is configured to detect supply pressure of the low oxygen air LA in the low oxygen air supply unit 20, and is installed in the low oxygen air supply tube 13 in the low oxygen air supply unit 20. The second pressure sensor 36 is configured to detect supply pressure of the high oxygen atmosphere HA in the low oxygen air supply unit 20, and is installed in the high oxygen atmosphere supply tube 14 in the low oxygen air supply unit 20.

The control device 50 calculates supply quantity (flow rate) of the low oxygen air LA in the low oxygen air supply unit 20 in accordance with information such as a detection value (pressure) of the first pressure sensor 35 and a tube diameter of the low oxygen air supply tube 13. The control device 50 calculates supply quantity (flow rate) of the high oxygen atmosphere HA in the low oxygen air supply unit 20 in accordance with information such as a detection value (pressure) of the second pressure sensor 36 and a tube diameter of the high oxygen atmosphere supply tube 14.

The control device 50 is further connected to the third pressure sensor 67, a fourth pressure sensor 68, and a fifth pressure sensor 69. The third pressure sensor 67, the fourth pressure sensor 68, and the fifth pressure sensor 69 are installed in the machine chamber A2.

The third pressure sensor 67 is configured to detect supply pressure of the low oxygen air LA, and is installed in the low oxygen air supply tube 13 having been merged at the second silencer 62. The fourth pressure sensor 68 is configured to detect supply pressure of the high oxygen atmosphere HA, and is installed in the high oxygen atmosphere supply tube 14 having been merged at the third silencer 63. The fifth pressure sensor 69 is configured to detect supply pressure of the outdoor air OA, and is installed at the outdoor air duct 15.

The control device 50 calculates total supply quantity of the low oxygen air LA in the low oxygen air supply system 10 in accordance with information such as the detection value of the third pressure sensor 67 and the tube diameter of the low oxygen air supply tube 13. The control device 50 calculates total supply quantity of the high oxygen atmosphere HA in the low oxygen air supply system 10 in accordance with information such as a detection value of the fourth pressure sensor 68 and the tube diameter of the high oxygen atmosphere supply tube 14. The control device 50 calculates supply quantity of the outdoor air OA in the low oxygen air supply system 10 in accordance with a detection value of the fifth pressure sensor 69. The low oxygen air supply system 10 according to the present disclosure may alternatively exclude the fifth pressure sensor 69. In this case, the control device 50 may calculate the supply quantity of the outdoor air OA in accordance with a number of fan revolutions and an operation current value of the supply fan 40.

In the low oxygen air supply system 10, the supply fan 40 executes class 2 ventilation of the indoor space A1 and keeps positive pressure in the indoor space A1 to inhibit entry of any unexpected air to the indoor space A1 (disturbance) so as to inhibit oxygen concentration variation in the indoor space A1. The control device 50 may adjust the supply quantity of the outdoor air OA in accordance with the detection values of the carbon dioxide sensors 58 (i.e., carbon dioxide concentration in the indoor space A1). In this case, the control device 50 adjusts the supply quantity of the outdoor air OA to the indoor space A1 by turning ON or OFF the supply fan 40 or changing the number of fan revolutions of the supply fan 40.

The control device 50 is configured to individually control behavior of each of the low oxygen air supply units 20 connected thereto. Upon detection of any trouble in part of the low oxygen air supply units 20, the control device 50 stops the low oxygen air supply unit 20 in trouble and operates the remaining low oxygen air supply units 20 other than the low oxygen air supply unit 20 in trouble to continuously supply the low oxygen air LA. The low oxygen air supply system 10 according to the present embodiment can thus continuously operate even in such a case where part of the low oxygen air supply units 20 has trouble.

As depicted in FIG. 1 and FIG. 4A to FIG. 4C, the low oxygen air supply system 10 includes a first gate valve 64, a second gate valve 65, and a third gate valve 66. The first gate valve 64 is provided on the outdoor air supply tube 12 for a flow of the outdoor air OA to be supplied to the low oxygen air supply unit 20, and is configured to individually switch between supply and stoppage of the outdoor air OA from the first silencer 61 to each of the low oxygen air supply units 20. The second gate valve 65 is provided on the low oxygen air supply tube 13 for a flow of the low oxygen air LA generated in the low oxygen air supply unit 20, and is configured to individually switch between supply and stoppage of the low oxygen air LA from each of the low oxygen air supply units 20 to the second silencer 62. The third gate valve 66 is provided on the high oxygen atmosphere supply tube 14 for a flow of the high oxygen atmosphere HA generated in the low oxygen air supply unit 20, and is configured to individually switch between supply and stoppage of the high oxygen atmosphere HA from each of the low oxygen air supply units 20 to the third silencer 63.

In a case where one of the low oxygen air supply units 20 has trouble, the low oxygen air supply system 10 closes any one the gate valves 64 to 66 corresponding to the low oxygen air supply unit 20 in trouble so as to replace the low oxygen air supply unit 20 in trouble while the low oxygen air supply system 10 is continuously operating. The low oxygen air supply system 10 according to the present embodiment can thus repair the low oxygen air supply system 10 without stopping supply of the low oxygen air LA (provision of the low oxygen environment) even upon trouble in part of the low oxygen air supply units 20.

The low oxygen air supply system 10 described above includes the plurality of low oxygen air supply units 20 configured to generate the low oxygen air LA lower in oxygen concentration than the air and supply the indoor space A1 with the low oxygen air LA thus generated, the supply fan 40 configured to supply the indoor space A1 with the outdoor air OA, the oxygen sensor 57 configured to detect oxygen concentration in the indoor space A1, the carbon dioxide sensor 58 configured to detect carbon dioxide concentration in the indoor space A1, and the control device 50 configured to control behavior of the low oxygen air supply units 20 and the supply fan 40. Even in a case where any of the low oxygen air supply units 20 has trouble, the low oxygen air supply system 10 thus configured can continuously supply the low oxygen air LA with use of the remaining low oxygen air supply units 20. The low oxygen air supply system 10 can thus secure supply quantity of the low oxygen air LA necessary for keeping the low oxygen environment even in such a case where part of the low oxygen air supply units 20 has trouble, so as to continuously provide the low oxygen environment.

### (Regarding Correction of Oxygen Sensor and Carbon Dioxide Sensor)

The low oxygen air supply system 10 according to the present disclosure includes the two oxygen sensors 57 (the first oxygen sensor 57a and the second oxygen sensor 57b). The control device 50 in the low oxygen air supply system 10 can thus compare a detection value of the first oxygen sensor 57a with a detection value of the second oxygen sensor 57b.

In a case where the oxygen sensors 57 have any abnormal detection value during operation of the low oxygen air supply system 10, the control device 50 compares the detection values of the oxygen sensors 57a and 57b so as to determine whether abnormality in the indoor space A1 or trouble in any of the oxygen sensors 57 causes the abnormal detection value. The control device 50 determines whether or not the oxygen sensors 57 have trouble in accordance with a result of comparison between the detection values of the oxygen sensors 57a and 57b, a difference from a reference detection value of each of the oxygen sensors 57a and 57b, a change situation of the abnormal detection value, and the like.

The low oxygen air supply system 10 according to the present disclosure includes the two carbon dioxide sensors 58 (the first carbon dioxide sensor 58a and the second carbon dioxide sensor 58b). The control device 50 in the low oxygen air supply system 10 can thus compare a detection value of the first carbon dioxide sensor 58a with a detection value of the second carbon dioxide sensor 58b.

In a case where the carbon dioxide sensors 58 have any abnormal detection value during operation of the low oxygen air supply system 10, the control device 50 compares the detection values of the carbon dioxide sensors 58a and 58b so as to determine whether abnormality in the indoor space A1 or trouble in any of the carbon dioxide sensors 58 causes the abnormal detection value. The control device 50 determines whether or not the carbon dioxide sensors 58 have trouble in accordance with a result of comparison between the detection values of the carbon dioxide sensors 58a and 58b, a difference from a reference detection value of each of the carbon dioxide sensors 58a and 58b, a change situation of the abnormal detection value, and the like.

The low oxygen air supply system 10 includes the two oxygen sensors 57 and the two carbon dioxide sensors 58 to exactly control behavior of the low oxygen air supply units 20 so as to reliably keep oxygen concentration in the indoor space A1 in a desired low oxygen state as well as reliably monitor oxygen concentration and carbon dioxide concentration in the indoor space A1.

The low oxygen air supply system 10 includes the two oxygen sensors 57 and the two carbon dioxide sensors 58 so as to accurately correct the oxygen sensors 57 and the carbon dioxide sensors 58. Upon correction of the oxygen sensors 57 and the carbon dioxide sensors 58, the low oxygen air supply system 10 stops the low oxygen air supply units 20 and operate the supply fan 40 so as to supply the indoor space A1 being vacant with only the outdoor air OA. In this case, the indoor space A1 is equal in oxygen concentration (about 21%) to the ordinary air, and is equal in carbon dioxide concentration (about 300 to 400 ppm) to the ordinary air.

The low oxygen air supply system 10 compares actually measured values with the oxygen concentration (about 21%) of the ordinary air assumed as a correction reference value to correct the two oxygen sensors 57a and 57b. The low oxygen air supply system 10 compares actually measured values with the carbon dioxide concentration (about 300 to 400 ppm) of the ordinary air assumed as a correction reference value to correct the two carbon dioxide sensors 58a and 58b. In this manner, the configuration including the two oxygen sensors 57 and the carbon dioxide sensors 58 has comparison targets for deviation of the measured values with the correction reference value, and facilitates deterioration or abnormality of the sensors 57 and 58. the low oxygen air supply system 10 may alternatively include sensors having a self correction function as the oxygen sensors 57 and the carbon dioxide sensors 58.

### (Regarding Business Schedule)

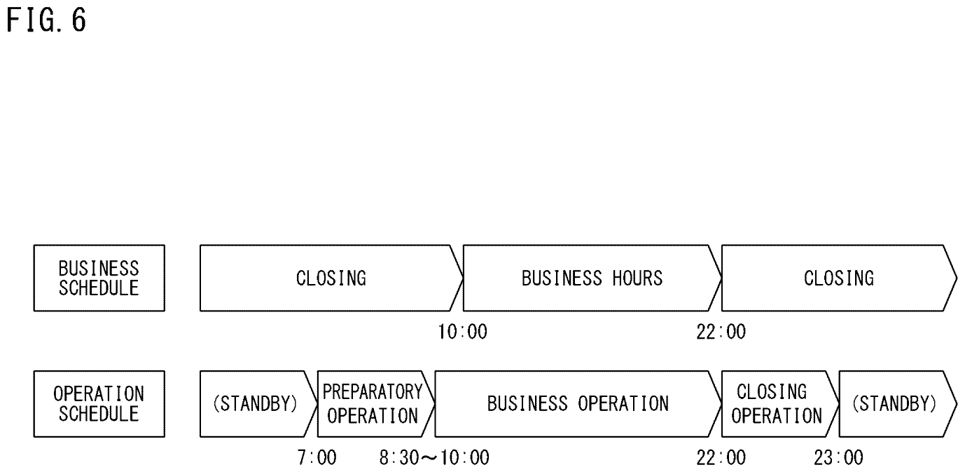

FIG. 6 is an exemplary chart of a business schedule of a store adopting the low oxygen air supply system and an operation schedule of the low oxygen air supply system. The low oxygen air supply system 10 according to the present embodiment operates in accordance with an operation schedule depicted in FIG. 6. As depicted in FIG. 6, the operation schedule of the low oxygen air supply system 10 is set in accordance with the business schedule of the store adopting the low oxygen air supply system 10. The present embodiment exemplifies a case where the store has a daily business hours for 12 hours from 10:00 am to 10:00 pm. The present embodiment exemplifies a case where the store is closed except for 10:00 am to 10:00 pm. The business schedule of the store adopting the low oxygen air supply system is not limited to the schedule exemplified in the present embodiment. The business schedule of the store may have exemplarily 24 business hours and may be closed once in several days. In this case, the low oxygen air supply system 10 executes a preparatory operating mode and a closing operating mode to be described later at closing timing in the several days, and continuously executes a business operating mode during the business hours.

### (Regarding Operation Schedule)

As depicted in FIG. 5, the operation schedule of the low oxygen air supply system 10 includes preparatory operation, business operation, closing operation, and a standby state. In the following description, the operating mode of the low oxygen air supply system 10 during the preparatory operation will be referred to as the preparatory operating mode, the operating mode of the low oxygen air supply system 10 during the business operation will be referred to as the business operating mode, and the operating mode of the low oxygen air supply system 10 during the closing operation will be referred to as the closing operating mode. The following description assumes a mode of the low oxygen air supply system 10 in the standby state as a standby mode.

The preparatory operating mode is executed for transition of the oxygen concentration in the indoor space A1 from oxygen concentration equivalent to the oxygen concentration in the outdoor space A3 to an oxygen concentration (low oxygen concentration) suitable for business at timing before the business hours start. The low oxygen air supply system 10 according to the present embodiment exemplarily sets 7:00 am to 8:30 am as an execution period for the preparatory operating mode. The preparatory operating mode ends at timing slightly before the business hours start in the present embodiment. The low oxygen air supply system 10 may alternatively continue the preparatory operating mode until the business hours start.

The business operating mode is executed for keeping the oxygen concentration in the indoor space A1 at oxygen concentration suitable for business (low oxygen concentration at about 16%) during the business hours. The low oxygen air supply system 10 according to the present embodiment exemplarily sets 8:30 am to 10:00 pm as an execution period for the business operating mode. The low oxygen air supply system 10 may adopt a schedule having transition from the preparatory operating mode to the business operating mode at timing before the business hours start as exemplified in the present embodiment.

The closing operating mode is executed for transition of the oxygen concentration in the indoor space A1 from the low oxygen concentration suitable for business to the oxygen concentration equivalent to the oxygen concentration in the outdoor space A3 at timing after the business hours ends. The low oxygen air supply system 10 according to the present embodiment exemplarily sets 10:00 pm to 11:00 pm as an execution period for the closing operating mode.

The standby mode is executed for keeping the oxygen concentration in the indoor space A1 equivalent to the oxygen concentration in the outdoor space A3 without supplying the indoor space A1 with the low oxygen air LA while the store is closed (timing before and after the business hours). In other words, the standby mode is executed for keeping the indoor space A1 to have an ordinary oxygen concentration. The low oxygen air supply system 10 according to the present embodiment exemplarily sets 11:00 pm to 7:00 am on the following day as an execution period for the standby mode.

### (Regarding Preparatory Operating Mode)

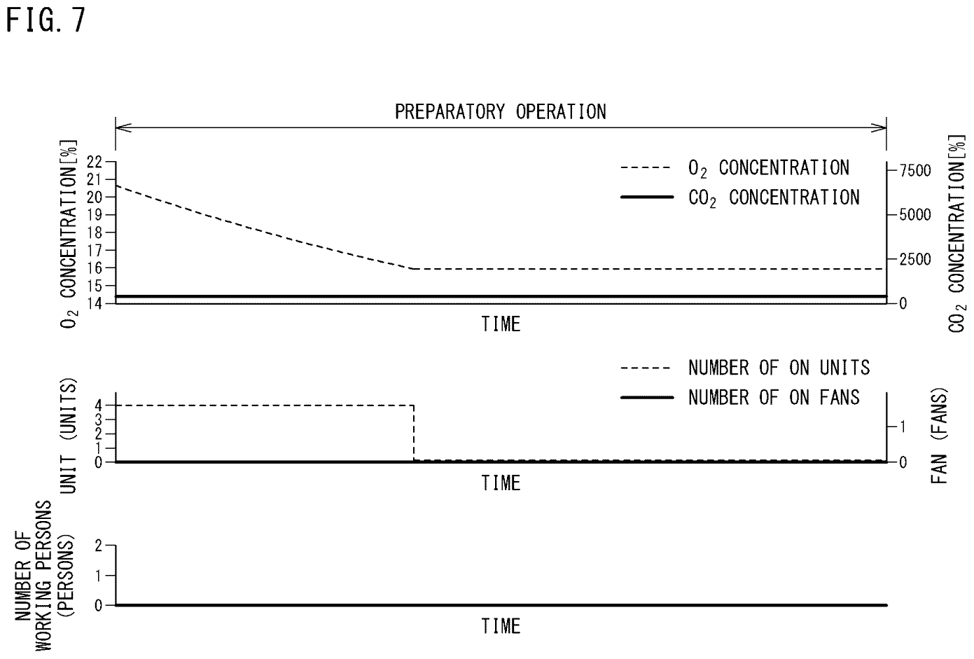

FIG. 7 includes graphs indicating oxygen concentration and carbon dioxide concentration during preparatory operation, the numbers of low oxygen air supply units and supply fans, and a change in the number of users of the low oxygen air supply system. As indicated in FIG. 7, the preparatory operating mode is executed for transition of the oxygen concentration in the indoor space A1 from the state equivalent to the outdoor space A3 into a low oxygen state (about 16%). The present embodiment assumes “zero” as the number of persons in the indoor space A1 during execution of the preparatory operating mode. In the preparatory operating mode, all the (four) low oxygen air supply units 20 included in the integral unit 11 are actuated to supply the indoor space A1 with the low oxygen air LA. The supply fan 40 is stopped in the preparatory operating mode. In this manner, in the preparatory operating mode, the indoor space A1 is supplied with the low oxygen air LA in a state where the indoor space A1 is not ventilated and the indoor space A1 has neither consumption of oxygen nor generation of carbon dioxide. The low oxygen air supply system 10 executes the preparatory operating mode so as to quickly decrease the oxygen concentration in the indoor space A1 into the low oxygen state. As indicated in FIG. 7, through execution of the preparatory operating mode, the low oxygen air supply system 10 can quickly decrease an oxygen concentration in the indoor space A1 of about 20 to 21% at a starting point to the low oxygen state of about 16%. In the preparatory operating mode, the number of the actuated low oxygen air supply units 20 is changed from four to zero once the oxygen concentration in the indoor space A1 has reached the desired low oxygen state (about 16%).

The control device 50 in the low oxygen air supply system 10 according to the present disclosure is configured to calculate airtightness (a C value) of the indoor space A1 in accordance with change in oxygen concentration and carbon dioxide concentration during execution of the preparatory operating mode. By daily checking the airtightness (the C value) of the indoor space A1, the low oxygen air supply system 10 can detect deterioration in the airtightness of the indoor space A1 due to deterioration at a sealed portion, deterioration of a building itself, and the like.

### (Regarding Business Operating Mode)

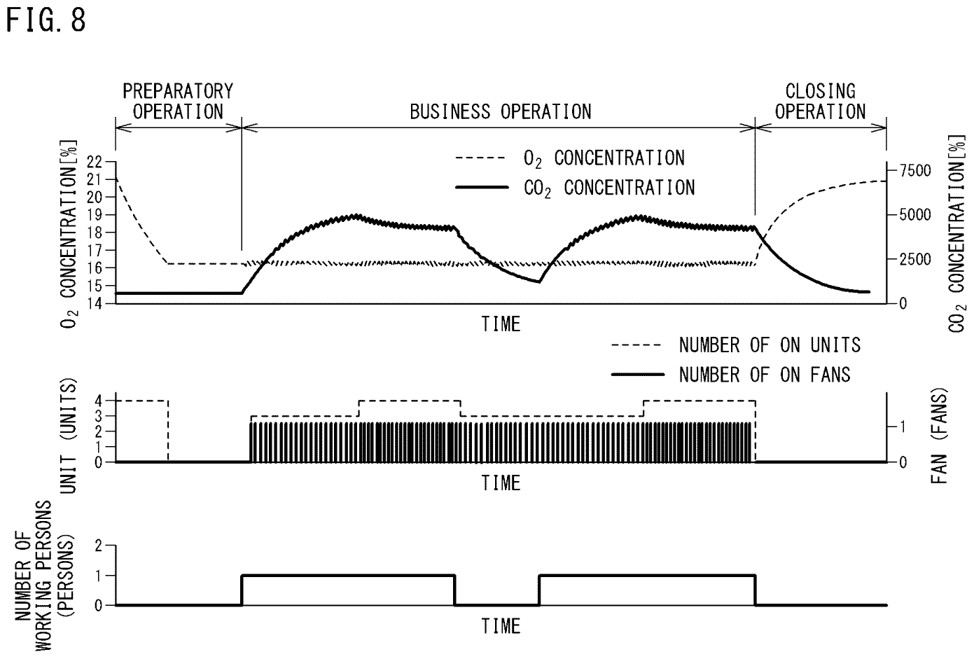

FIG. 8 includes graphs indicating oxygen concentration and carbon dioxide concentration during business operation, the numbers of low oxygen air supply units and supply fans, and a change in the number of users of the low oxygen air supply system. As indicated in FIG. 8, the business operating mode is executed for keeping the oxygen concentration in the indoor space A1 in the low oxygen state (about 16%). The present embodiment assumes “zero to one” as the number of persons in the indoor space A1 during execution of the business operating mode. In the business operating mode, the number of the actuated low oxygen air supply units 20 included in the integral unit 11 controlled between zero and four (both inclusive) in accordance with the carbon dioxide concentration in the indoor space A1. The integral unit 11 supplies the indoor space A1 with the low oxygen air LA necessary for keeping the low oxygen state (about 16%). In the business operating mode, the supply fan 40 is controlled to be ON or OFF in accordance with the carbon dioxide concentration in the indoor space A1. As indicated in FIG. 8, through execution of the business operating mode, the low oxygen air supply system 10 can keep the oxygen concentration in the indoor space A1 to the low oxygen state of about 16% as well as can inhibit an increase in carbon dioxide concentration in the indoor space A1. When the number of the low oxygen air supply units 20 is controlled in the low oxygen air supply system 10 according to the present disclosure, the control device 50 considers integrated operation time of the low oxygen air supply units 20 and selects the low oxygen air supply units 20 to be stopped and actuated such that the low oxygen air supply units 20 are leveled in terms of the integrated operation time.

### (Regarding Closing Operating Mode)

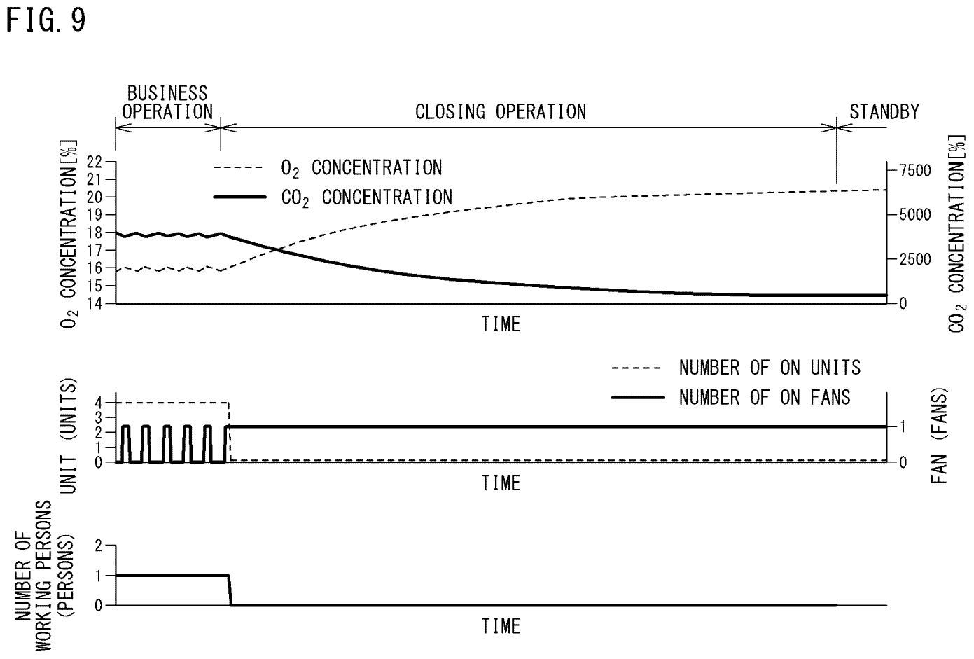

FIG. 9 includes graphs indicating oxygen concentration and carbon dioxide concentration during closing operation, the numbers of low oxygen air supply units and supply fans, and a change in the number of users of the low oxygen air supply system. As indicated in FIG. 9, the closing operating mode is executed for transition of the oxygen concentration in the indoor space A1 from the low oxygen state (about 16%) into the state equivalent to the outdoor space A3. The present embodiment assumes “zero” as the number of persons in the indoor space A1 during execution of the closing operating mode. In the closing operating mode, all the low oxygen air supply units 20 included in the integral unit 11 are stopped to stop supply of the low oxygen air LA into the indoor space A1. In the closing operating mode, the supply fan 40 is always ON to supply the indoor space A1 with the outdoor air OA for ventilation. As indicated in FIG. 9, through execution of the closing operating mode, the low oxygen air supply system 10 according to the present disclosure can increase the oxygen concentration in the indoor space A1 from about 16% to about 20 to 21%. Through execution of the closing operating mode, the low oxygen air supply system 10 according to the present disclosure can decrease the carbon dioxide concentration in the indoor space A1 from about 3000 ppm to about 300 to 400 ppm.

### (Regarding Standby Mode)

As indicated in FIG. 7 and FIG. 9, the standby mode is executed for keeping the oxygen concentration in the indoor space A1 to be equivalent to the oxygen concentration in the outdoor space A3 (about 20 to 21%). The present embodiment assumes “zero” as the number of persons in the indoor space A1 in the standby mode. In the standby mode, all the low oxygen air supply units 20 included in the integral unit 11 are stopped to stop supply of the low oxygen air LA into the indoor space A1. The supply fan 40 is turned OFF in the standby mode. As indicated in FIG. 9, the low oxygen air supply system 10 according to the present disclosure can keep the oxygen concentration in the indoor space A1 at about 20 to 21% as well as can keep the carbon dioxide concentration in the indoor space A1 at about 300 400 ppm in the standby mode.

In the low oxygen air supply system 10 according to the present disclosure, the control device 50 operates the low oxygen air supply system 10 in accordance with the operation schedule to provide the low oxygen environment in the indoor space A1 of the store in accordance with the business schedule of the store. Even in a case where part of the low oxygen air supply units 20 has trouble, the low oxygen air supply system 10 can continuously provide the low oxygen environment by operating the remaining low oxygen air supply units 20 not in trouble. Adoption of the low oxygen air supply system 10 according to the present disclosure thus eliminates necessity for extraordinary closing of the store upon trouble in part of the low oxygen air supply units 20.

### (Regarding Operation Control)

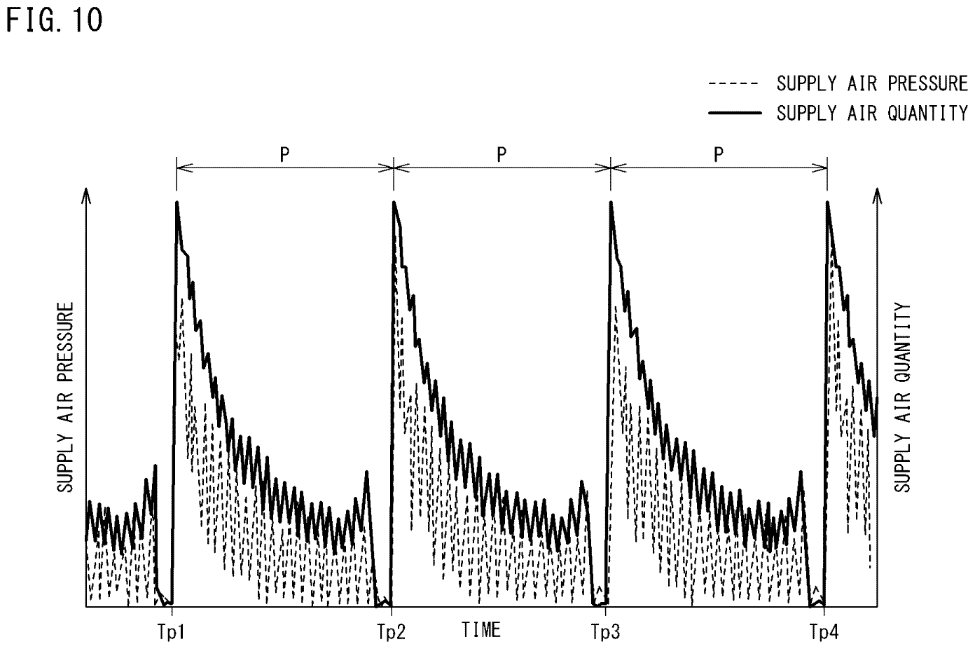

FIG. 10 is a graph indicating periodical variations of supply air quantity and supply air pressure of the low oxygen air supply unit. As indicated in FIG. 10, each of the low oxygen air supply units 20 according to the present embodiment has a characteristic (an operation cycle) that supply air quantity and supply air pressure of the low oxygen air LA vary with a predetermined period P. FIG. 10 indicates a case where the supply air quantity and the supply air pressure have peaks at time Tp1 to time Tp4. The low oxygen air supply units 20 have substantially matching peaks of the supply air quantity and the supply air pressure. In the following description, time of the peaks of the supply air quantity and the supply air pressure will also be referred to as peak time Tp. When the plurality of low oxygen air supply units 20 has the matched peak time Tp, the plurality of low oxygen air supply units 20 simultaneously supply the low oxygen air LA at the peak time Tp and the low oxygen air supply system 10 thus has a large variation range of the supply quantity of the low oxygen air LA. In this case, the low oxygen air supply system 10 has an increased maximum value of a power value (current x voltage), and further generates larger noise.

In the low oxygen air supply system 10 according to the present disclosure, the control device 50 adjusts the operation cycle of the low oxygen air supply units 20 in operation such that the low oxygen air supply units 20 have the peak time Tp being unmatched.

In this case, the low oxygen air supply units 20 have power values (current×voltage) maximized at different timing, so as to have leveled in terms of power consumption. Furthermore, the supply quantities of the low oxygen air LA and the high oxygen atmosphere HA from the low oxygen air supply units 20 are maximized at different timing so as to decrease the maximum supply quantities of the low oxygen air LA and the high oxygen atmosphere HA and thus level the supply quantities of the low oxygen air LA and the high oxygen atmosphere HA. Moreover, this achieves a decrease in the tube diameter of each of the second silencer 62 where the low oxygen air LA supplied from the low oxygen air supply units 20 merges, the third silencer 63 where the high oxygen atmosphere HA merges, and the first silencer 61 where the outdoor air OA to be supplied to the low oxygen air supply units 20 merges. Furthermore, the maximum supply quantities of the low oxygen air LA and the high oxygen atmosphere HA are decreased so as to inhibit noise generated from the low oxygen air supply units 20 when the low oxygen air LA and the high oxygen atmosphere HA are exhausted and the outdoor air OA is sucked.

Each of the low oxygen air supply units 20 described above includes the adsorbent X configured to adsorb and separate nitrogen. The low oxygen air supply unit 20 includes the first adsorption column 25a and the second adsorption column 25b each accommodating the adsorbent X, the compressor 22 configured to supply air to one of the first adsorption column 25a and the second adsorption column 25b, the vacuum pump 23 configured to exhaust air from the other one of the first adsorption column 25a and the second adsorption column 25b, and the first switching valve 24a and the second switching valve 24b configured to switch to one of the first adsorption column 25a and the second adsorption column 25b as an air supply target of the compressor 22 and switch to the other one of the first adsorption column and the second adsorption column as an exhaust source of the vacuum pump 23. In the low oxygen air supply unit 20, the first switching valve 24a and the second switching valve 24b switch the air supply target of the compressor 22 and the exhaust source of the vacuum pump 23. In the low oxygen air supply unit 20 thus configured, air supply quantity of the compressor 22 and air exhaust quantity of the vacuum pump 23 are periodically varied when the first switching valve 24a and the second switching valve 24b switch flow paths. In the low oxygen air supply system 10, the control device 50 controls behavior of the low oxygen air supply units 20 such that the low oxygen air supply units 20 have the peak time Tp differentiated from one another.

The low oxygen air supply system 10 thus configured can inhibit power consumption and noise generation, as well as can level the supply quantities of the low oxygen air LA and the high oxygen atmosphere HA.

### (Functional Effects of Embodiments)

(1) The low oxygen air supply system 10 according to each of the embodiments described above includes the plurality of low oxygen air supply units 20 configured to generate the low oxygen air LA lower in oxygen concentration than air and supply the indoor space A1 with the low oxygen air LA thus generated, the supply fan 40 configured to supply the indoor space A1 with the outdoor air OA, the oxygen sensor 57 configured to detect oxygen concentration in the indoor space A1, and the control device 50 configured to control behavior of the low oxygen air supply units 20 and the supply fan 40.

Even in a case where any of the low oxygen air supply units 20 has trouble, the low oxygen air supply system 10 can continuously supply the low oxygen air LA with use of the remaining low oxygen air supply unit 20. The low oxygen air supply system 10 according to the present disclosure can thus continuously provide the low oxygen environment even in such a case where part of the low oxygen air supply units 20 has trouble.

(2) In the low oxygen air supply system 10 according to the above embodiment, the low oxygen air supply units 20 each include the adsorbent X configured to adsorb nitrogen (or oxygen) contained in air and separate adsorbed nitrogen (or oxygen), the first adsorption column 25a and the second adsorption column 25b each accommodating the adsorbent X, the compressor 22 configured to supply air to one of the first adsorption column 25a and the second adsorption column 25b or the first open valve 37 configured to atmospherically open the one, the vacuum pump 23 configured to exhaust air from the other one of the first adsorption column 25a and the second adsorption column 25b or the second open valve 38 configured to atmospherically open the other one, and the first switching valve 24a and the second switching valve 24b each configured to switch a supply target of the compressor 22 or an open target of the first open valve 37 to one of the first adsorption column 25a and the second adsorption column 25b and switch an exhaust source of the vacuum pump 23 or an open source of the second open valve to the other one of the first adsorption column and the second adsorption column, and the control device 50 controls behavior of the low oxygen air supply units 20 such that first peak time Tp having a peak of air exhaust quantity from the vacuum pump 23 or the second open valve 38 in the first low oxygen air supply unit 20 is different from the second peak time Tp having a peak of air exhaust quantity from the vacuum pump 23 or the second open valve 38 in the second low oxygen air supply unit 20.

The low oxygen air supply system 10 thus configured can inhibit power consumption and noise generation of the low oxygen air supply system 10. The low oxygen air supply system 10 can be leveled in the supply quantity of the low oxygen air LA.

(3) The low oxygen air supply system 10 according to the above embodiment further includes the carbon dioxide sensor 58 configured to detect carbon dioxide concentration in the indoor space A1.

The low oxygen air supply system 10 thus configured enables management of the carbon dioxide concentration in the indoor space A1 as well as enables control of behavior of the low oxygen air supply system 10 in accordance with the carbon dioxide concentration.

(4) In the low oxygen air supply system 10 according to the above embodiment, the supply fan 40 executes class 2 ventilation of the indoor space A1.

The low oxygen air supply system 10 thus configured can inhibit variation in oxygen concentration in the indoor space A1.

(5) In the low oxygen air supply system 10 according to the above embodiment, the control device 50 is configured to individually control the low oxygen air supply units 20, and the second gate valve 65 is further provided on each of supply channels of the low oxygen air LA to be supplied from the low oxygen air supply units 20.

When any of the low oxygen air supply units 20 has trouble, the low oxygen air supply system 10 thus configured can continuously operate with use of the remaining low oxygen air supply unit 20 and can replace the low oxygen air supply unit 20 in trouble.

(6) The low oxygen air supply system 10 according to the above embodiment further includes the third pressure sensor 67 configured to detect supply pressure of the low oxygen air. The control device 50 calculates supply quantity of the low oxygen air LA in accordance with the detection value of the third pressure sensor 67.

The low oxygen air supply system 10 thus configured does not need to include a separate flow rate sensor configured to measure supply quantity of the low oxygen air LA.

(7) The low oxygen air supply system 10 according to the above embodiment includes the two oxygen sensors 57 (the first oxygen sensor 57a and the second oxygen sensor 57b), as well as the two carbon dioxide sensors 58 (the first carbon dioxide sensor 58a and the second carbon dioxide sensor 58b).

The low oxygen air supply system 10 thus configured can determine either occurrence of abnormality of an excessively low oxygen state where the oxygen concentration exceeds a predetermined range in the indoor space A1 or occurrence of abnormality to detection values of the sensors 57 and 58 themselves. The oxygen sensors 57 and the carbon dioxide sensors 58 can be corrected through comparison between the detection values of the sensors 57 and 58.

(8) The low oxygen air supply system 10 according to the above embodiment further includes the first silencer 61. In the low oxygen air supply system 10, the first silencer 61 merges the low oxygen air LA supplied from the first low oxygen air supply unit 20 and the low oxygen air LA supplied from the second low oxygen air supply unit 20.

The low oxygen air supply system 10 thus configured can be reduced in the number of silencers in comparison to a case where each of the low oxygen air supply units 20 is provided with a silencer. Noise generated from the low oxygen air supply system 10 can be effectively reduced with the smaller number of silencers.

(9) The low oxygen air supply system 10 according to the above embodiment further includes the rack 70. In the low oxygen air supply system 10, the low oxygen air supply units 20 are mounted on the rack 70.

The low oxygen air supply system 10 thus configured facilitates installation of the low oxygen air supply system 10.

(10) In the low oxygen air supply system 10 according to the above embodiment, each of the low oxygen air supply units 20 further generates a high oxygen atmosphere higher in oxygen concentration than air, and supplies the high oxygen chamber A4 with the high oxygen atmosphere HA. The low oxygen air supply unit 20 further includes the flow rate control valve 30 configured to adjust supply quantity of the high oxygen atmosphere HA. The control device 50 adjusts the opening degree of the flow rate control valve 30 to adjusts the supply quantity of the high oxygen atmosphere HA.

In the low oxygen air supply system 10 thus configured, the flow rate of the low oxygen air LA can be adjusted when the flow rate of the high oxygen atmosphere HA is adjusted. The flow rate control valve 30 provided in the tube system for the high oxygen atmosphere HA is smaller in size than the flow rate control valve provided in the tube system for the low oxygen air LA. The flow rate of the low oxygen air LA can thus be adjusted with use of the flow rate control valve 30 smaller in size, which enables cost reduction for the flow rate control valve 30.

(11) The low oxygen air supply system 10 according to the above embodiment further includes the third oxygen sensor 57c disposed in the high oxygen chamber A4. The control device 50 calculates supply capacity of the low oxygen air LA to be supplied into the indoor space A1 in accordance with the detection value of the third oxygen sensor 57c disposed in the high oxygen chamber A4 or the like.

This enables comparison between supply capacity of the low oxygen air LA calculated in accordance with detection values of the third pressure sensor 67, the oxygen sensors 57a and 57b, and the like in the indoor space A1, and supply capacity of the low oxygen air LA calculated in accordance with the detection value of the third oxygen sensor 57c disposed in the high oxygen chamber A4 or the like. This achieves facilitated checking that the low oxygen air supply system 10 is normally functioning.

While various embodiments have been described herein above, it is to be appreciated that various changes in form and detail may be made without departing from the spirit and scope presently or hereafter claimed.

1. A low oxygen air supply system comprising:
a first low oxygen air supply unit and a second low oxygen air supply unit, each of the first low oxygen air supply unit and the second low oxygen air supply unit being configured to generate a low oxygen air lower in oxygen concentration than air and supply a first target space with the low oxygen air thus generated;
a fan configured to supply the first target space with outdoor air;
at least one oxygen sensor configured to detect oxygen concentration in the first target space; and
a control unit configured to control behavior of the first low oxygen air supply unit, the second low oxygen air supply unit, and the fan.

2. The low oxygen air supply system according to claim 1, wherein
the first low oxygen air supply unit and the second low oxygen air supply unit each include
an adsorbent configured to adsorb nitrogen or oxygen contained in air and separate adsorbed nitrogen or oxygen,
a first adsorption column and a second adsorption column each accommodating the adsorbent,
a compressor configured to supply air to one of the first adsorption column and the second adsorption column or a first open valve configured to atmospherically open the one,
a vacuum pump configured to exhaust air from another one of the first adsorption column and the second adsorption column or a second open valve configured to atmospherically open the other one, and
a switching valve configured to switch a supply target of the compressor or an open target of the first open valve to the first adsorption column or the second adsorption column and switch an exhaust source of the vacuum pump or an open source of the second open valve to the first adsorption column or the second adsorption column not corresponding to the supply target of the compressor or the open target of the first open valve, and
the control unit is configured to control behavior of the first low oxygen air supply unit and the second low oxygen air supply unit such that first time having a peak of air exhaust quantity from the vacuum pump or the second open valve in the first low oxygen air supply unit is different from second time having a peak of air exhaust quantity from the vacuum pump or the second open valve in the second low oxygen air supply unit.

3. The low oxygen air supply system according to claim 1, further comprising:
at least one carbon dioxide sensor configured to detect carbon dioxide concentration in the first target space.

4. The low oxygen air supply system according to claim 1, wherein
the fan executes class 2 ventilation of the first target space.

5. The low oxygen air supply system according to claim 1, wherein
the control unit is configured to individually control the first low oxygen air supply unit and the second low oxygen air supply unit, and
a gate valve is further provided on each of a supply channel of the low oxygen air supplied from the first low oxygen air supply unit and a supply channel of the low oxygen air supplied from the second low oxygen air supply unit.

6. The low oxygen air supply system according to claim 1, further comprising:
a pressure sensor configured to detect supply pressure of the low oxygen air,
the control unit being configured to calculate supply quantity of the low oxygen air in accordance with a detection value of the pressure sensor.

7. The low oxygen air supply system according to claim 1, wherein
the at least one oxygen sensor includes two or more oxygen sensors, and at least one carbon dioxide sensor includes two or more carbon dioxide sensors.

8. The low oxygen air supply system according to claim 1, further comprising:
a silencer, the silencer merging the low oxygen air supplied from the first low oxygen air supply unit and the low oxygen air supplied from the second low oxygen air supply unit.

9. The low oxygen air supply system according to claim 1, further comprising:
a rack,
the first low oxygen air supply unit and the second low oxygen air supply unit being mounted on the rack.

10. The low oxygen air supply system according to claim 1, wherein
each of the first low oxygen air supply unit and the second low oxygen air supply unit
is configured to generate a high oxygen atmosphere higher in oxygen concentration than air, to supply a second target space with the high oxygen atmosphere, and
includes a flow rate control valve configured to adjust supply quantity of the high oxygen atmosphere, and
the control unit is configured to adjust an opening degree of the flow rate control valve to adjust the supply quantity of the high oxygen atmosphere.

11. The low oxygen air supply system according to claim 10, wherein
the oxygen sensor is disposed in the second target space, and
the control unit is configured to calculate supply capacity of the low oxygen air to be supplied into the first target space in accordance with a detection value of the oxygen sensor in the second target space.

12. The low oxygen air supply system according to claim 2, further comprising:
at least one carbon dioxide sensor configured to detect carbon dioxide concentration in the first target space.

13. The low oxygen air supply system according to claim 2, wherein
the fan executes class 2 ventilation of the first target space.

14. The low oxygen air supply system according to claim 2, wherein
the control unit is configured to individually control the first low oxygen air supply unit and the second low oxygen air supply unit, and
a gate valve is further provided on each of a supply channel of the low oxygen air supplied from the first low oxygen air supply unit and a supply channel of the low oxygen air supplied from the second low oxygen air supply unit.

15. The low oxygen air supply system according to claim 2, further comprising:
a pressure sensor configured to detect supply pressure of the low oxygen air,
the control unit being configured to calculate supply quantity of the low oxygen air in accordance with a detection value of the pressure sensor.

16. The low oxygen air supply system according to claim 2, wherein
the at least one oxygen sensor includes two or more oxygen sensors, and at least one carbon dioxide sensor includes two or more carbon dioxide sensors.

17. The low oxygen air supply system according to claim 2, further comprising:
a silencer, the silencer merging the low oxygen air supplied from the first low oxygen air supply unit and the low oxygen air supplied from the second low oxygen air supply unit.

18. The low oxygen air supply system according to claim 2, further comprising:
a rack,
the first low oxygen air supply unit and the second low oxygen air supply unit being mounted on the rack.

19. The low oxygen air supply system according to claim 2, wherein
each of the first low oxygen air supply unit and the second low oxygen air supply unit
is configured to generate a high oxygen atmosphere higher in oxygen concentration than air, to supply a second target space with the high oxygen atmosphere, and
includes a flow rate control valve configured to adjust supply quantity of the high oxygen atmosphere, and
the control unit is configured to adjust an opening degree of the flow rate control valve to adjust the supply quantity of the high oxygen atmosphere.

20. The low oxygen air supply system according to claim 19, wherein
the oxygen sensor is disposed in the second target space, and
the control unit is configured to calculate supply capacity of the low oxygen air to be supplied into the first target space in accordance with a detection value of the oxygen sensor in the second target space.
